(19) United States
(12) Patent Application Publication
(10) Pub. No.: US 2022/0107551 A1
(43) Pub. Date: Apr. 7, 2022

(54) STROBE DEVICE AND IMAGING DEVICE

(71) Applicant: PANASONIC INTELLECTUAL PROPERTY MANAGEMENT CO., LTD., Osaka-shi Osaka (JP)

(72) Inventor: Takuma KIKUCHI, Osaka (JP)

(21) Appl. No.: 17/426,445

(22) PCT Filed: Jan. 20, 2020
(86) PCT No.: PCT/JP2020/001694

§ 371 Date: Jul. 28, 2021

(30) Foreign Application Priority Data
Jan. 30, 2019 (JP) 2019-013712

(51) Int. Cl. G03B 15/05

(52) U.S. Cl. CPC G03B 15/05

(57) ABSTRACT

Provided is a strobe device that can properly illuminate a subject with flash light according to distances from a light-emitting unit to side walls as well as a ceiling. A strobe device 10 performs bounce photography in which flash light is emitted to a reflector so as to illuminate a subject with light reflected from the reflector including a ceiling H1 and side walls H2 and H3 that reflect the flash light. The strobe device further includes a distance-measuring unit capable of measuring distances from a light-emitting unit 13 to the subject, the ceiling H1, and at least one of the left side wall H2 and the right side wall H3. A control unit controls a drive unit such that the light-emitting unit 13 has a bounce angle based on distances other than a distance from the light-emitting unit 13 to the subject, the distances including a distance from the light-emitting unit 13 to a main reflector that is the ceiling H1 or at least one of the left side wall H2 and the right side wall H3 and distances from the light-emitting unit 13 to auxiliary reflectors other than the main reflector.

### TECHNICAL FIELD

The present invention relates to a strobe device that is mounted on an imaging device and is capable of changing the angle and orientation of a light-emitting unit (a strobe device capable of changing the direction and angle of radiation), and an imaging device including the strobe device.

### BACKGROUND ART

To capture a more natural image, it has been a common practice to perform bounce photography in which flash light from the light-emitting unit of a strobe device is directed toward a reflector, e.g., a ceiling or a wall, is scattered therefrom, and indirectly illuminates a subject to capture an image of the subject. In the bounce photography, an image is captured while a light-emitting surface of the light-emitting unit (a surface for emitting light from the light-emitting unit) is not opposed to the subject but is directed in a desired direction to a reflector, e.g., a ceiling or a wall.

A control unit of the strobe device automatically controls a bounce angle between a shooting direction, which is the optical axis direction of a taking lens, and a direction of emitting flash light (in a desired direction to the reflector), allowing the light-emitting unit to always emit flash light to the reflector (see Patent Literatures 1 and 2). A strobe device and an imaging device described in Patent Literatures 1 and 2 direct the taking lens of the imaging device toward a ceiling and a subject (or one side wall (a right side wall or a left side wall) and a subject as will be described later), measure distances by automatic focusing or the like, and set a bounce angle based on the distances.

Patent Literature 2 describes a strobe device that can perform bounce photography by switching modes even if a ceiling serving as a reflector for bounce photography is replaced with the side wall (the left side wall or the right side wall).

### CITATION LIST

### Patent Literatures

Patent Literature 1: Japanese Patent Laid-Open No. 2009-163179

Patent Literature 2: Japanese Patent Laid-Open No. 2014-38268

### SUMMARY OF INVENTION

### Technical Problem

In the strobe device and the imaging device disclosed in Patent Literatures 1 and 2, unfortunately, a bounce angle is set on the assumption that flash light is reflected only by a reflector on one surface, e.g., a ceiling or one of the side walls (the right side wall or the left side wall). Thus, for example, in the case of a subject close to one of the side walls (the right side wall or the left side wall) as well as a ceiling, light emission simply inclined toward the ceiling (that is, without being horizontally inclined) may cause intensive reflection of flash light not only from the ceiling but also the side wall (both or one of the side walls (the right side wall or the left side wall)) close to the subject. This may lead to bounce photography with light shifted to the left or right while being emitted to the subject, thereby preventing proper illumination of the subject.

The present invention has been devised to solve the problem. An object of the present invention is to provide a strobe device and an imaging device, by which a subject can be properly illuminated with flash light according to distances from a light-emitting unit to side walls as well as a ceiling.

### Solution to Problem

In order to solve the problem, a strobe device of the present invention includes: a strobe main unit; a light-emitting unit connected to the strobe main unit so as to rotate in three-dimensional directions: an up-down direction, a front-back direction, and a right-left direction with respect to the strobe main unit; an adjustable mechanism for changing an angle and orientation of the light-emitting unit with respect to the strobe main unit in the rotatable range; a drive unit for driving the adjustable mechanism; and a control unit for controlling the drive unit, the strobe device enabling bounce photography in which flash light is emitted to a reflector so as to illuminate a subject with light reflected from the reflector including a ceiling and side walls that reflect the flash light, the strobe device further including a distance-measuring unit capable of measuring distances from the light-emitting unit to the subject, the ceiling, and at least one of the left side wall and the right side wall, wherein the control unit controls the drive unit such that the light-emitting unit has a bounce angle based on distances other than a distance from the light-emitting unit to the subject, the distances including a distance from the light-emitting unit to a main reflector that is the ceiling or one of the left side wall and the right side wall and distances from the light-emitting unit to auxiliary reflectors other than the main reflector.

With this configuration, the control unit controls the drive unit such that the light-emitting unit has a proper bounce angle based on distances including a distance from the light-emitting unit to the main reflector that is the ceiling or at least one of the left side wall and the right side wall and distances from the light-emitting unit to the auxiliary reflectors other than the main reflector. Thus, in addition to light reflected from the main reflector, e.g., the ceiling to the subject, flash light can properly illuminate the subject while equalizing the levels of reflection from the other reflectors to the subject.

According to the strobe device of the present invention, the distance-measuring unit is capable of measuring distances from the light-emitting unit to the subject, the ceiling, the left side wall, and the right side wall, and if the distance from the light-emitting unit to one of the side walls is smaller than the distance from the light-emitting unit to the ceiling and the distance from the light emitting unit to the other side wall is larger than the distance from the light-emitting unit to the ceiling, the control unit controls the drive unit so as to incline the light-emitting unit toward a position close to the other side wall on the ceiling.

Unlike in the reflection of flash light to the ceiling without the horizontal inclination of the strobe device, this configuration can reduce the amount of reflection from one of the side walls at a smaller distance than the ceiling from the light-emitting unit and increase the amount of reflection from the other side wall at a larger distance than the ceiling from the light-emitting unit. This equalizes the levels of reflection from one of the side walls and the other side wall to the subject, thereby properly illuminating the subject with flash light.

According to the strobe device of the present invention, if the distance from the light-emitting unit to one of the side walls is smaller than the distance from the light-emitting unit to the ceiling and the distance from the light-emitting unit to the other side wall is larger than the distance from the light-emitting unit to the ceiling, the control unit controls the drive unit such that a position of light emission on the ceiling by the light-emitting unit is shifted from a position directly above the light-emitting unit toward the other side wall according to a dimension corresponding to a difference between the distance to the ceiling and the distance to one of the side walls.

With this configuration, the smaller the distance from the light-emitting unit to one of the side walls relative to the distance from the light-emitting unit to the ceiling, the larger the inclination of the position of light emission on the ceiling by the light-emitting unit toward the other side wall. This equalizes more properly the levels of reflection from one of the side walls and the other side wall to the subject, thereby properly illuminating the subject with flash light.

According to the strobe device of the present invention, the distance-measuring unit is capable of measuring distances from the light-emitting unit to the subject, the ceiling, the left side wall, and the right side wall, and if the distances from the light-emitting unit to one of the side walls and the other side wall are smaller than the distance from the light-emitting unit to the ceiling, the control unit controls the drive unit such that the light-emitting unit is directed toward a point at equal distances from the side walls on the ceiling.

With this configuration, also in the case where the distances from the light-emitting unit to one of the side walls and the other side wall are smaller than the distance from the light-emitting unit to the ceiling, the levels of reflection from one of the side walls and the other side wall to the subject are more properly equalized unlike in the reflection of flash light to the ceiling without the horizontal inclination of the light-emitting unit. Thus, the subject can be properly illuminated with flash light.

According to the strobe device of the present invention, the distance-measuring unit is capable of measuring distances from the light-emitting unit to the subject, the ceiling, the left side wall, and the right side wall, and if the distances from the light-emitting unit to the side walls are not smaller than the distance from the light-emitting unit to the ceiling, the control unit controls the drive unit such that the light-emitting unit is directed toward the ceiling without being horizontally inclined.

With this configuration, if the distances from the light-emitting unit to the left and right side walls are not smaller than the distance from the light-emitting unit to the ceiling, the effect of reflection from the left and right walls is small, and the control unit controls the drive unit such that the light-emitting unit is directed toward the ceiling without being horizontally inclined. Thus, the subject can be properly illuminated with flash light.

According to the strobe device of the present invention, the distance-measuring unit measures distances from the light-emitting unit to the subject, the ceiling, and one of the left side wall and the right side wall, and if the distance from the light-emitting unit to one of the side walls is larger than the distance from the light-emitting unit to the ceiling, the control unit controls the drive unit such that the light-emitting unit is directed toward the ceiling without being horizontally inclined, and if the distance from the light-emitting unit to one of the side walls is smaller than the distance from the light-emitting unit to the ceiling, the control unit controls the drive unit so as to incline the light-emitting unit toward a position close to the other opposite side wall on the ceiling.

With this configuration, only the distance from the light-emitting unit to one of the side walls is measured. Only in the case where the distance from the light-emitting unit to one of the side walls is smaller than the distance from the light-emitting unit to the ceiling, the light-emitting unit is inclined toward a position close to the other opposite side wall on the ceiling. Thus, the subject can be properly illuminated with flash light. Since only the distance from the light-emitting unit to one of the side walls is measured, bounce photography can be performed in a shorter time than in the measurement of distances from the light-emitting unit to both of the left and right side walls.

According to the strobe device of the present invention, if the distance from the light-emitting unit to one of the side walls is smaller than the distance from the light-emitting unit to the ceiling, the control unit controls the drive unit such that a position of light emission on the ceiling by the light-emitting unit is shifted from a position directly above the light-emitting unit toward the other side wall according to a dimension corresponding to a difference between the distance to the ceiling and the distance to one of the side walls.

According to the strobe device of the present invention, the distance-measuring unit measures a distance from the light-emitting unit to the main reflector including one of the left side wall and the right side wall and a distance from the light-emitting unit to the auxiliary reflector including the ceiling, and the control unit controls the drive unit such that the light-emitting unit is inclined toward a position close to the ceiling on one of the left side wall and the right side wall according to the distance from the light-emitting unit to one of the side walls and the distance from the light-emitting unit to the ceiling. In this case, if the distance from the light-emitting unit to the ceiling is smaller than the distance from the light-emitting unit to one of the side walls, the control unit preferably controls the drive unit so as to incline the light-emitting unit toward a position close to the ceiling on one of the side walls.

With this configuration, mainly in the case of photo-taking with flash light reflected from the left side wall or the right side wall, the subject can be properly illuminated with flash light along with reflected light from the ceiling while suppressing a shadow of the subject in a direction opposite to the side wall serving as a main reflector.

An imaging device of the present invention includes the strobe device. With this configuration, the imaging device can properly illuminate the subject with flash light.

### ADVANTAGEOUS EFFECT OF INVENTION

As has been discussed, a strobe device that enables bounce photography according to the present invention includes the light-emitting unit connected to the strobe main unit so as to rotate in three-dimensional directions. The strobe device further includes the distance-measuring unit capable of measuring distances from the light-emitting unit to the subject, the ceiling, and at least one of the left side wall and the right side wall. The control unit controls the drive unit such that the light-emitting unit has a bounce angle based on distances other than a distance from the light-emitting unit to the subject, the distances including a distance from the light-emitting unit to the main reflector that is the ceiling or one of the left side wall and the right side wall and distances from the light-emitting unit to auxiliary reflectors other than the main reflector. Thus, in addition to light reflected from the main reflector, e.g., the ceiling to the subject, flash light can properly illuminate the subject while equalizing the levels of reflection from the other auxiliary reflectors to the subject.

### BRIEF DESCRIPTION OF DRAWINGS

FIG. 1 is a block diagram illustrating the configuration of an imaging device including a strobe device according to an embodiment of the present invention.

FIG. 2 is a side view of the strobe device.

FIG. 3 is a plan view of the strobe device.

FIG. 4 is an explanatory drawing of a flash coverage that can be set in an up-down direction and a front-back direction by the strobe device.

FIG. 5 is an explanatory drawing of a flash coverage that can be set in a right-left direction by the strobe device.

FIG. 6 is a conceptual diagram illustrating a room for bounce photography using the strobe device.

FIG. 7 is a side view indicating a distance being measured from the light-emitting unit of the strobe device to a subject.

FIG. 8 is a side view indicating a distance being measured from the light-emitting unit of the strobe device to a ceiling.

FIG. 9 is a plan view indicating a distance being measured from the light-emitting unit of the strobe device to a left side wall and a distance being measured from the light-emitting unit to a right side wall.

FIG. 10A is a flowchart indicating operations when an auto bounce mode for the strobe device is selected.

FIG. 10B is a flowchart indicating operations when the auto bounce mode for the strobe device is selected.

FIG. 11 is a rear view of the strobe device.

FIG. 12 is a side view indicating an angle of the light-emitting unit of the strobe device in the vertical direction during the bounce photography.

FIG. 13 is a side view indicating the angle of the light-emitting unit of the strobe device in the vertical direction during the bounce photography.

FIG. 14 is a side view indicating an angle of the light-emitting unit of the strobe device in the right-left direction during the bounce photography while only a distance from the light-emitting unit to the left side wall is smaller than a distance from the light-emitting unit to the ceiling.

FIG. 15 is a side view indicating an angle of the light-emitting unit of the strobe device in the right-left direction during the bounce photography while only a distance from the light-emitting unit to the right side wall is smaller than a distance from the light-emitting unit to the ceiling.

FIG. 16 is a rear view indicating an angle of the light-emitting unit of the strobe device in the right-left direction during the bounce photography while a distance from the light-emitting unit to the left side wall and a distance from the light-emitting unit to the right side wall are smaller than a distance to the ceiling.

FIG. 17 is a flowchart indicating operations for selecting a mode for bounce photography (bounce mode) of the strobe device.

FIG. 18A is a flowchart indicating the operations of a one-side distance-measuring bounce mode for the strobe device.

FIG. 18B is a flowchart indicating the operations of the one-side distance-measuring bounce mode for the strobe device.

FIG. 19 is a rear view of the strobe device indicating that a distance from the light-emitting unit to the left side wall is not smaller than a distance from the light-emitting unit to the ceiling in the one-side distance-measuring bounce mode.

FIG. 20 is a rear view of the strobe device when a distance from the light-emitting unit to the left side wall is smaller than a distance from the light-emitting unit to the ceiling.

FIG. 21 is a rear view of the strobe device when a distance from the light-emitting unit to the right side wall is not smaller than a distance from the light-emitting unit to the ceiling in the one-side distance-measuring bounce mode.

FIG. 22 is a rear view of the strobe device when a distance from the light-emitting unit to the right side wall is smaller than a distance from the light-emitting unit to the ceiling.

FIG. 23 is a flowchart indicating the operations of a side-wall bounce mode for the strobe device.

FIG. 24 is a plan view indicating a photo-taking state in the side-wall bounce mode for the strobe device.

FIG. 25 is a rear view indicating the photo-taking state in the side-wall bounce mode for the strobe device.

FIG. 26 is a flowchart indicating the operations of a modification of the side-wall bounce mode for the strobe device.

### DESCRIPTION OF EMBODIMENT

A strobe device and an imaging device including the strobe device according to an embodiment of the present invention will be described below in accordance with the accompanying drawings. The embodiment is merely exemplary, and the present invention is not always limited to the embodiment.

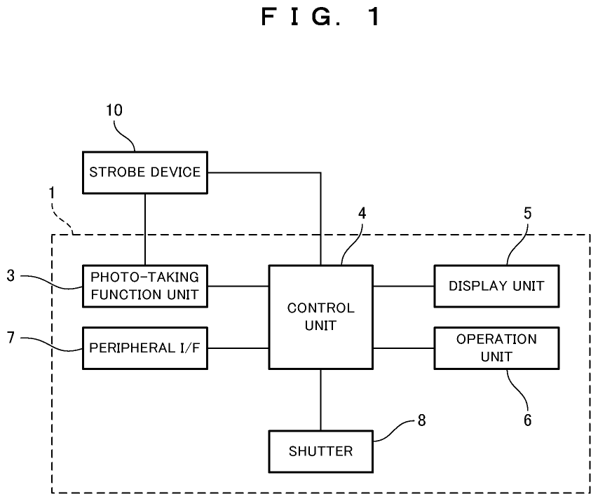

As illustrated in FIG. 1, an imaging device 1 according to the embodiment of the present invention is configured with a strobe device 10 for emitting flash light to a subject, the strobe device 10 being attachable to the imaging device 1. The imaging device 1 includes a photo-taking function unit 3 for taking a photograph of a subject, a control unit 4 for controlling the strobe device 10 and the photo-taking function unit 3 (a control unit that is provided in the imaging device 1 and controls the overall imaging device 1 including the strobe device 10), a display unit 5 for displaying, for example, an image of the subject, an operation unit 6 for switching the settings of photo-taking conditions or power supplies, a peripheral I/F (interface) 7 for inputting and outputting image data or the like from and to peripheral devices, a shutter 8 operated by a user (photographer) to take a photograph of the subject with flash light from the strobe device 10, and the like.

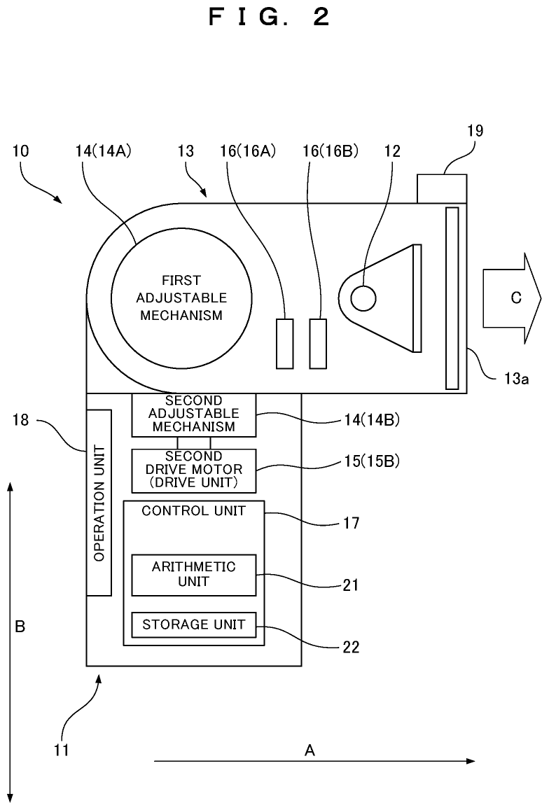

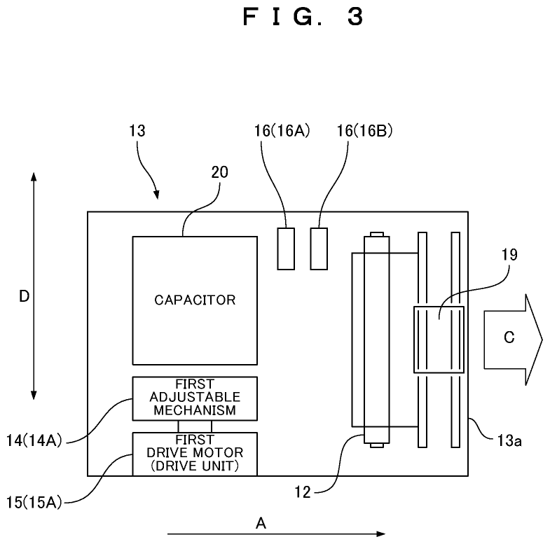

As illustrated in FIGS. 2 and 3, the strobe device 10 includes a strobe main unit 11, a light-emitting unit 13 that is connected to the strobe main unit 11 so as to rotate in three-dimensional directions: an up-down direction, a front-back direction, and a right-left direction, and accommodates a stroboscopic tube 12 for emitting light to the outside, an adjustable mechanism 14 for changing the angle and orientation of the light-emitting unit 13 with respect to the strobe main unit 11 in a rotatable range, a drive unit 15 for driving the adjustable mechanism 14, an angle detection unit 16 for detecting the angle of the light-emitting unit 13 with respect to the strobe main unit 11, a control unit 17 for controlling the strobe device 10, an operation unit 18 that is provided on the strobe main unit 11 and inputs various set values or selects various modes, a distance sensor 19 acting as a distance-measuring unit, a capacitor (power accumulator) 20 for accumulating power for light emission, and the like.

The strobe main unit 11 has, for example, a substantially box-shaped housing. The light-emitting unit 13 is connected to the top surface of the strobe main unit 11 so as to rotate in three-dimensional directions: an up-down direction, a front-back direction, and a right-left direction. Moreover, the underside of the strobe main unit 11 is connectable to the top surface of the imaging device 1. The strobe main unit 11 is connectable to the imaging device 1 with the front side facing in a shooting direction A (in the optical axis direction of a taking lens provided for the imaging device 1) of the imaging device 1.

The light-emitting unit 13 has, for example, a substantially box-shaped housing and an opening 13a on one side of the housing. Light from the stroboscopic tube 12 is emitted through the opening 13a. The light-emitting unit 13 is configured so as to change a radiation direction C of flash light, for example, by changing the tilt angle and orientation of the opening 13a with respect to a vertical direction B.

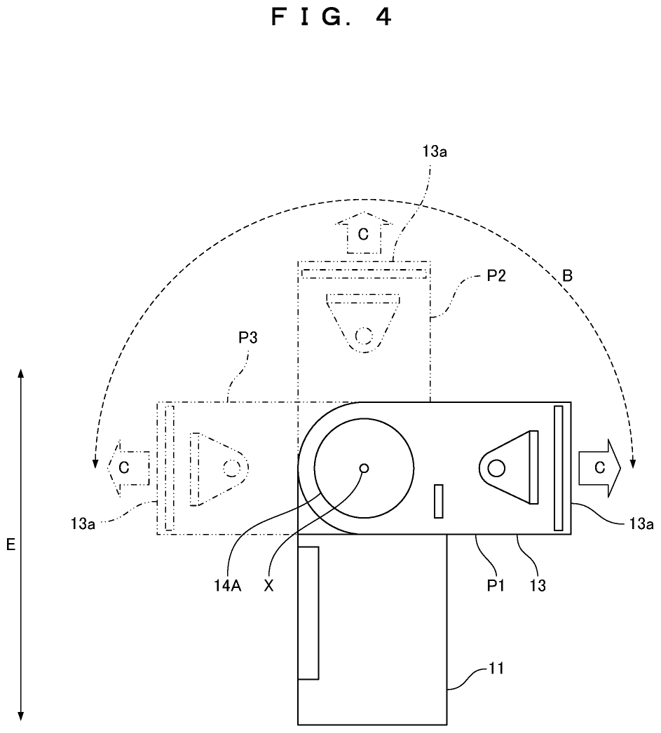

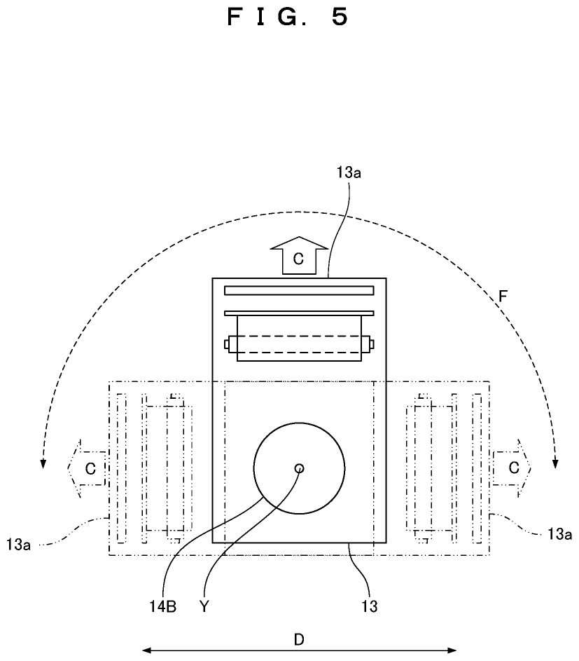

As illustrated in FIGS. 4 and 5, the adjustable mechanism 14 is connected so as to rotate the light-emitting unit 13 in three-dimensional directions: the front-back direction, the up-down direction, and the right-left direction with respect to the strobe main unit 11. Specifically, the adjustable mechanism 14 includes a first adjustable mechanism 14A capable of rotating the light-emitting unit 13 in the vertical direction and a front-back direction B (also simply referred to as a vertical direction B) with respect to a lateral axis X provided along a width direction D of the strobe main unit 11, and a second adjustable mechanism 14B capable of rotating the light-emitting unit 13 in a right-left direction (and the front-back direction) (also referred to as a horizontal direction) F in a horizontal plane with respect to a longitudinal axis Y provided in a vertical direction (height direction) E of the strobe main unit 11.

As illustrated in FIG. 4, the first adjustable mechanism 14A is provided so as to change the angle and orientation of the light-emitting unit 13 in the vertical direction B. More specifically, the first adjustable mechanism 14A is provided so as to change the angle and orientation of the light-emitting unit 13 in the vertical direction B in a range from a normal radiation-direction angle (an angle when the light-emitting unit 13 is located at a normal photo-taking position P1) to a desired radiation-direction angle that is set by a user and is different from the normal radiation-direction angle (an angle when the light-emitting unit 13 is located at a bounce photography position P3). In the present embodiment, the first adjustable mechanism 14A has a structure that is rotatable to a rotation angle of 180° in the vertical direction. The first adjustable mechanism 14A is not limited to this structure. The first adjustable mechanism 14A may have a structure rotatable to a rotation angle smaller than 180° in the vertical direction or a structure rotatable to a rotation angle larger than 180° in the vertical direction.

As illustrated in FIG. 5, the second adjustable mechanism 14B is provided so as to change the angle and orientation of the light-emitting unit 13 in the horizontal direction F. In the present embodiment, the second adjustable mechanism 14B has a structure that is rotatable to a rotation angle of 180° in the horizontal direction. The second adjustable mechanism 14B is not limited to this structure. The second adjustable mechanism 14B may have a structure rotatable to a rotation angle slightly smaller than 180° in the horizontal direction or a structure rotatable to a rotation angle larger than 180° in the horizontal direction.

As illustrated in FIGS. 2 and 3, the drive unit 15 includes a first drive unit 15A for driving the first adjustable mechanism 14A and a second drive unit 15B for driving the second adjustable mechanism 14B. As illustrated in FIG. 3, the first drive unit 15A includes a first drive motor for rotating the first adjustable mechanism 14A. As illustrated in FIG. 2, the second drive unit 15B includes a second drive motor for rotating the second adjustable mechanism 14B.

As illustrated in FIG. 3, the angle detection unit 16 includes a first angle detection unit 16A for detecting the angle of the light-emitting unit 13 in the vertical direction B and a second angle detection unit 16B for detecting the angle of the light-emitting unit 13 in the horizontal direction F. The first angle detection unit 16A and the second angle detection unit 16B are provided in the light-emitting unit 13. The first angle detection unit 16A includes, for example, a triaxial acceleration sensor. The triaxial acceleration sensor is a sensor capable of detecting accelerations in the three directions of X, Y, and Z axes. The triaxial acceleration sensor of the present embodiment detects the tilt angle of the light-emitting unit 13 in the vertical direction B by detecting, for example, an acceleration of gravity at rest. The second angle detection unit 16B includes, for example, a magnetic field sensor. The magnetic field sensor is a sensor capable of detecting the magnitude and direction of a magnetic field. The magnetic field sensor of the present embodiment detects the tilt angle of the light-emitting unit 13 in the horizontal direction F by detecting the azimuth to which the light-emitting unit 13 faces. However, the first angle detection unit 16A and the second angle detection unit 16B are not limited to such a configuration, provided that the first angle detection unit 16A can detect the angle of the light-emitting unit 13 in the vertical direction B while the second angle detection unit 16B can detect the angle of the light-emitting unit 13 in the horizontal direction F.

The control unit 17 includes an arithmetic unit 21 for performing various kinds of arithmetic processing, and a storage unit 22 for storing various kinds of information. The control unit 17 includes, for example, a CPU (Central Processing Unit). The storage unit 22 includes RAM (Random Access Memory) or ROM (Read Only Memory) in a CPU or RAM or ROM that is externally connected to a CPU.

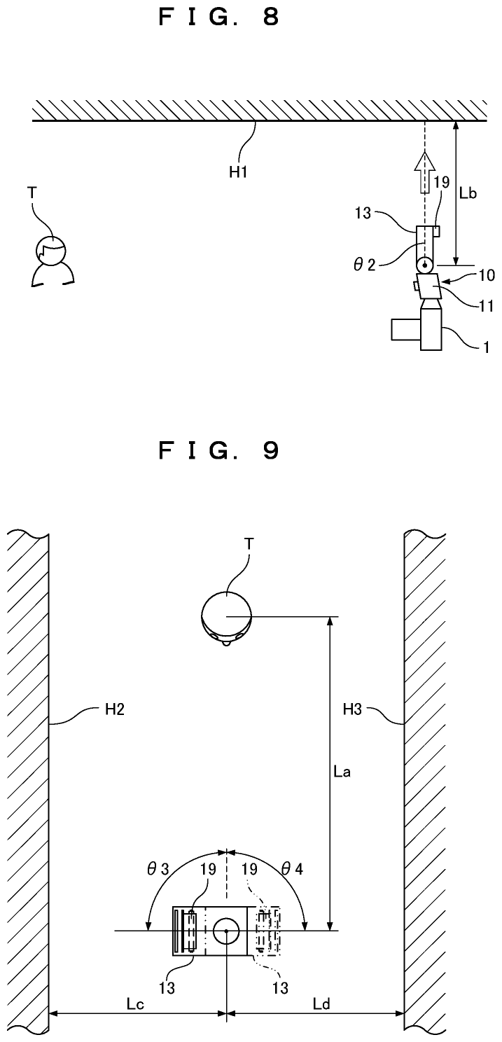

The distance sensor 19 has a first distance measuring function that can obtain a distance La (see FIG. 7) between the light-emitting unit 13 and a subject T, a second distance measuring function that can obtain a distance Lb (see FIG. 8) between the light-emitting unit and a ceiling (first reflector) H1, a third distance measuring function that can obtain a distance Lc (see a solid line part in FIG. 9) between the light-emitting unit 13 and a left side wall (second reflector) H2, and a fourth distance measuring function that can obtain a distance Ld (see a virtual line part in FIG. 9) between the light-emitting unit 13 and a right side wall (third reflector) H3. The distance sensor 19 is provided in the light-emitting unit 13. The distance sensor 19 is configured to measure distances to the subject T and the reflectors with the light-emitting unit 13 directed toward the subject T and the reflectors (the ceiling H1, the left side wall H2, the right side wall H3). In this way, the distance sensor 19 alone has all the distance measuring functions, thereby advantageously minimizing the number of components and the manufacturing cost.

The present invention is not limited to this configuration. The first to fourth distance measuring functions may be provided for different distance sensors.

Specifically, four distance sensors may be provided: a first distance sensor for measuring the distance La between the light-emitting unit 13 and the subject T, a second distance sensor for measuring the distance Lb between the light-emitting unit 13 and the ceiling (first reflector) H1, a third distance sensor for measuring the distance Lc between the light-emitting unit 13 and the left side wall (second reflector) H2, and a fourth distance sensor for measuring the distance Ld between the light-emitting unit 13 and the right side wall (third reflector) H3. The distance sensor 19 may be, but not limited to, an optical sensor, an infrared sensor, a supersonic sensor, or a laser beam sensor.

As illustrated in FIG. 7, the distance sensor 19 measures the distance La between the light-emitting unit and the subject T as first distance information when the light-emitting unit 13 is directed toward the subject T (specifically, when the angle of the light-emitting unit 13 is a subject angle θ1 with respect to a direction (also referred to as a reference longitudinal direction or a vertical direction) orthogonal to the ceiling (first reflector) H1). As illustrated in FIG. 8, the distance sensor 19 measures the distance Lb between the light-emitting unit 13 and the ceiling (first reflector) H1 as second distance information when the light-emitting unit is directed toward the ceiling (first reflector) H1 (specifically, when the light-emitting unit 13 has an angle θ2 (=0) with respect to the reference longitudinal direction). As indicated by a solid line in FIG. 9, the distance sensor 19 measures the distance Lc between the light-emitting unit 13 and the left side wall (second reflector) H2 as third distance information when the light-emitting unit 13 is directed (directed orthogonally) toward the left side wall (second reflector) H2 (specifically, when the light-emitting unit has an angle θ3 with respect to a direction (a reference horizontal direction) along which the light-emitting unit 13 is directed toward the subject T located in front of the light-emitting unit 13). As indicated by a virtual line in FIG. 9, the distance sensor 19 measures the distance Ld between the light-emitting unit 13 and the right side wall H3 as fourth distance information when the light-emitting unit 13 is directed toward the right side wall (third reflector) H3 (specifically, when the light-emitting unit 13 directed toward the right side wall H3 has an angle θ4 with respect to the reference horizontal direction).

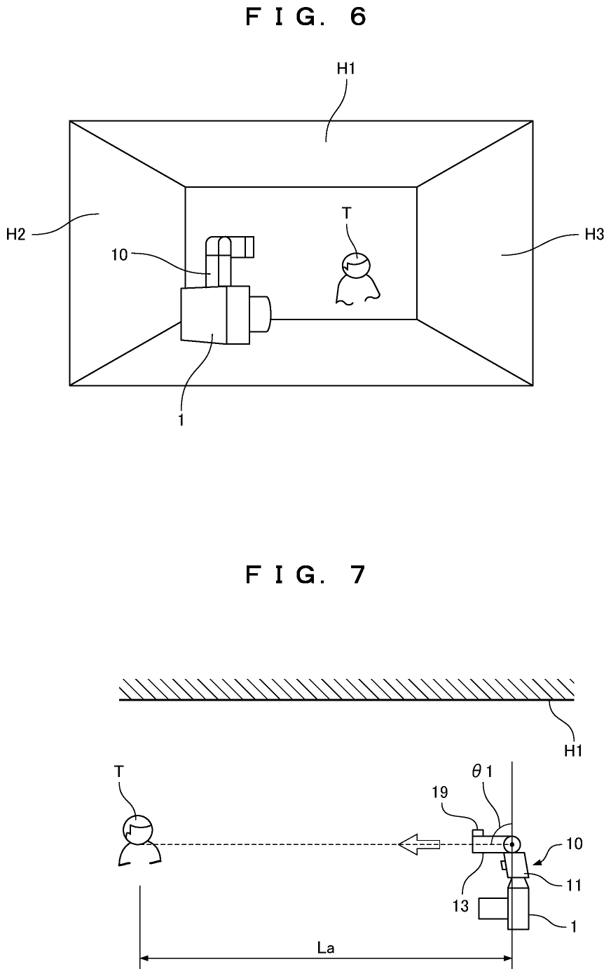

As illustrated in FIG. 6, the subject T is photographed in a room (space) surrounded by three reflectors: the ceiling H1, the left side wall H2, and the right side wall H3. For the sake of clarity, FIG. 6 illustrates the imaging device 1 and the subject T that are diagonally opposite to each other. The layout is not limited. The subject T may be photographed by the imaging device 1 facing the subject T in plan view (the subject T is located in front of (forward of) the imaging device 1 in plan view).

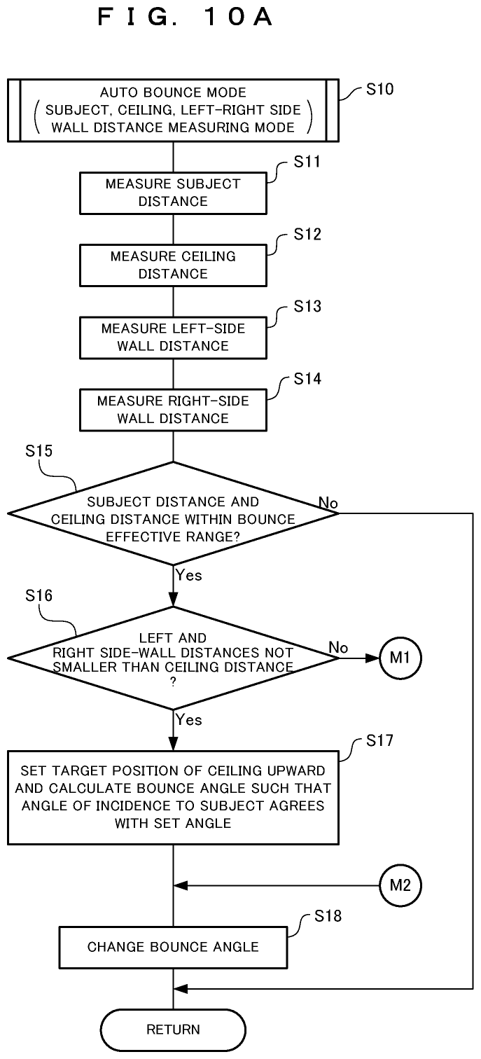

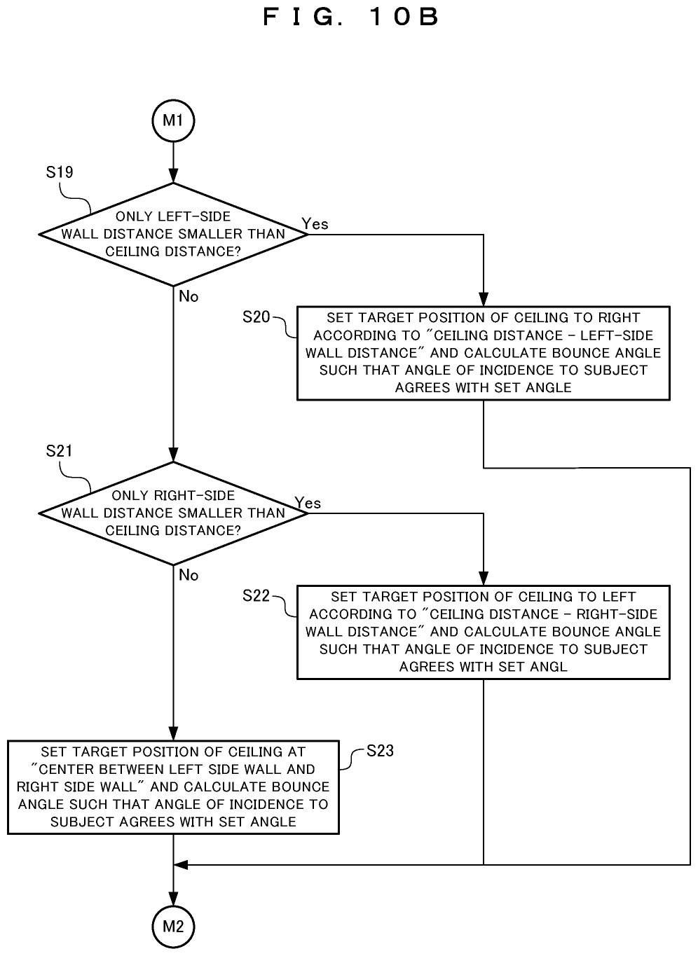

The strobe device 10 is configured to enable photography in an auto bounce mode (subject/ceiling/left-right side wall distance measuring mode) for bounce photography on the ceiling H1 along with the left and right side walls H2 and H3 (the ceiling H1 serves as a main reflector). Moreover, the operation unit 18 is operated so as to select the auto bounce mode (a mode indicated by step S10 in FIG. 10A). Furthermore, a distance to the subject T or the ceiling H1 (maximum effective distance) is preset to enable bounce photography.

When the auto bounce mode is selected, the distance sensor 19 serving as a distance measuring unit first measures distances to the subject T, the ceiling H1, the left side wall H2, and the right side wall H3 (from the light-emitting unit 13) (see steps S11 to S14 in FIG. 10A). In step S15, it is determined whether the distances to the subject T and the ceiling H1 fall within a distance range (bounce effective range) for enabling preset bounce photography. In step S15, if at least one of the subject T and the ceiling H1 is located at a distance out of the bounce effective range, the process is terminated without setting a bounce angle. For example, an error is indicated to provide a notification that the subject T or the ceiling H1 is located at a distance out of the bounce effective range; meanwhile, a normal photo-taking is continued.

In step S15, if it is determined that the distances to the subject T and the ceiling H1 fall within the bounce effective range, the process advances to step S16 to determine whether the distances Lc and Ld from the light-emitting unit 13 to the left side wall H2 and the right side wall H3 are not smaller than the distance Lb to the ceiling H1.

In step S16, if the distances Lc and Ld from the light-emitting unit 13 to the left side wall H2 and the right side wall H3 are not smaller than the distance Lb to the ceiling H1, the process advances to step S17. As illustrated in FIG. 11 (a view from the rear to the front (subject T) of the strobe device 10), the light-emitting unit 13 is directed toward the ceiling H1 (upward) (a target position on the ceiling H1 is simply set at an upward position) without being horizontally inclined, an angle of incidence to the subject T is calculated to be a tilt angle suitable for bounce photography, and the drive unit 15 is controlled to have the tilt angle (step S18).

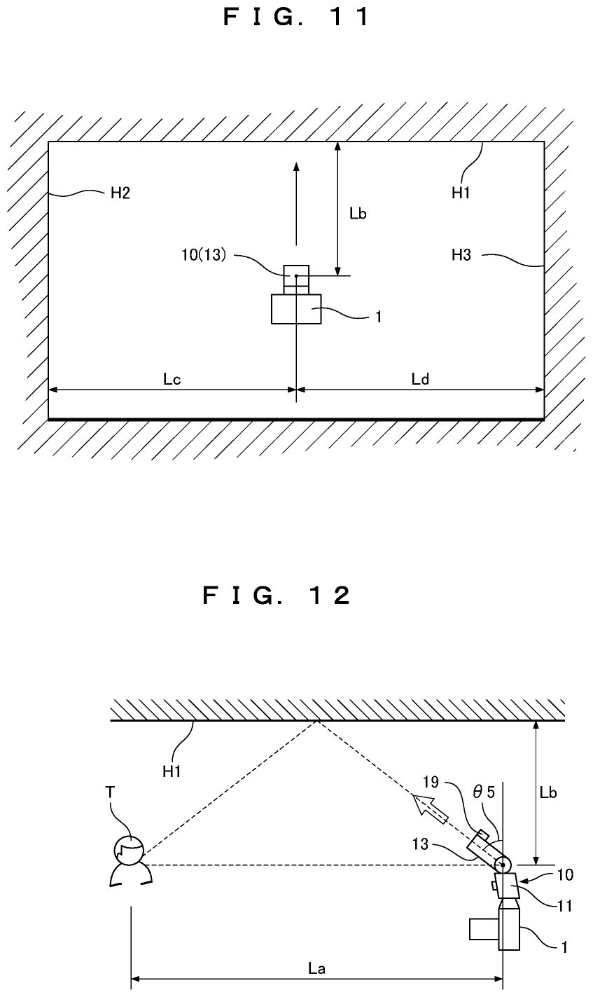

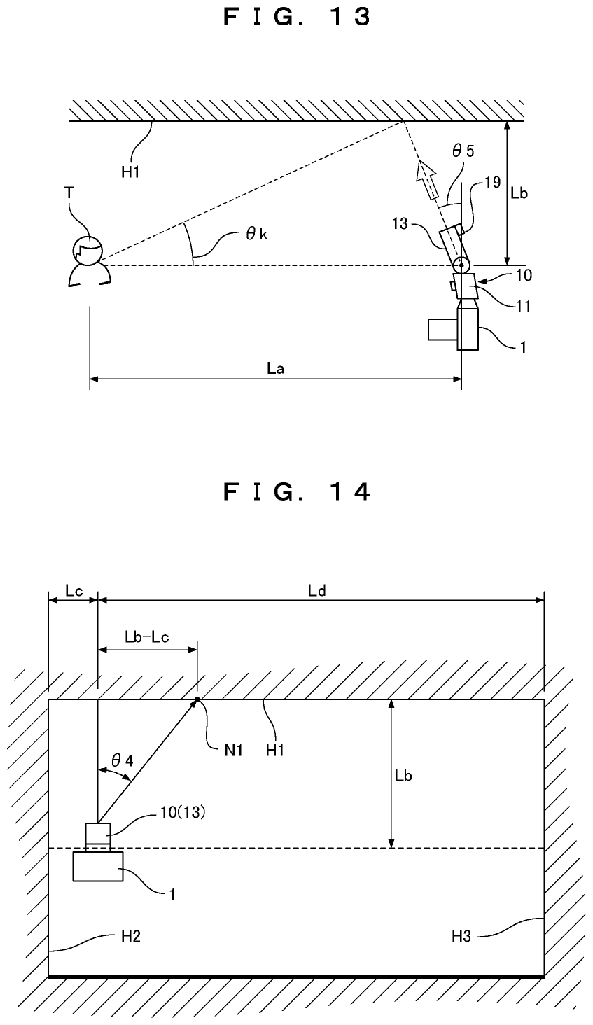

Specifically, as illustrated in FIG. 12 or 13, an arithmetic unit 24 of the control unit 17 calculates a proper bounce angle θ5 based on the distance La to the subject T and the distance Lb to the ceiling H1. As illustrated in FIG. 12, for example, the bounce angle θ5 is set such that an angle of incidence of flash light to the ceiling (first reflector) H1 agrees with an angle of outgoing flash light from the ceiling H1 to the subject T (step S18). The setting of the bounce angle θ5 is not limited. As illustrated in FIG. 13, the bounce angle θ5 may be determined such that an angle of incidence to the subject T agrees with a predetermined reference angle (e.g., about 30°) θk.

As illustrated in FIG. 13, the bounce angle θ5 is set such that the angle of incidence to the subject T agrees with the predetermined reference angle (e.g., about 30°), thereby advantageously maximizing the effect of bounce photography in any photo-taking environments unlike in the case where the angle of incidence of flash light to the ceiling H1 and the angle of outgoing flash light from the ceiling H1 to the subject T agree with each other. In other words, as illustrated in FIG. 12, if the light-emitting unit 13 is inclined such that an angle of incidence and an angle of reflection are equal to each other on the ceiling H1, the angle of incidence can be changed according to the distances La and Lb from the light-emitting unit 13 to the subject T and the ceiling H1. As the angle of incidence changes according to the distances La and Lb, the ratio of light from above varies during bounce photography. This changes the effect of bounce photography, accordingly. An extremely small angle of incidence to the subject T may cause a photo-taking result like direct light at worst, substantially eliminating the effect of bounce photography. To address the problem, as illustrated in FIG. 13, the angle of incidence is always controlled at an optimum tilt angle for bounce photography (for example, the angle of incidence to the subject T is set at 30°, a reference tilt angle), thereby maximizing the effect of bounce photography in any photo-taking environments.

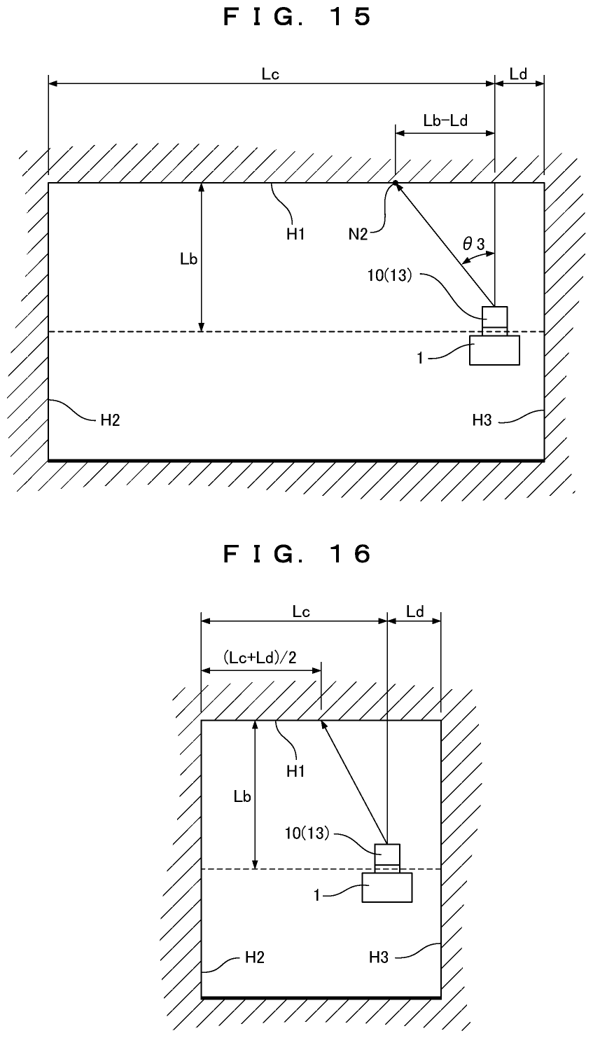

If only the distance Lc from the light-emitting unit 13 to the left side wall H2 is smaller than the distance Lb to the ceiling H1, that is, if the distance Lc from the light-emitting unit 13 to the left side wall H2 is smaller than the distance Lb to the ceiling H1 and the distance Ld from the light-emitting unit 13 to the right side wall H3 is not smaller than the distance Lb to the ceiling H1, the process advances from step S16 to steps S19 and S20 (see FIG. 10B). With respect to the right-left direction, as illustrated in FIG. 14, the drive unit is controlled to incline the light-emitting unit 13 toward a position close to the right side wall H3 on the ceiling H1.

If only the distance Lc from the light-emitting unit 13 to the left side wall H2 is smaller than the distance Lb from the light-emitting unit 13 to the ceiling H1, as indicated in step S20, the drive unit 15 is more preferably controlled such that the position of light emission on the ceiling H1 by the light-emitting unit 13 is located at a position N1 that is shifted from a position directly above the light-emitting unit 13 toward the right side wall H3 according to a dimension corresponding to a difference (Lb−Lc) between the distance Lb to the ceiling H1 and the distance Lc to the left side wall H2 (inclined to a bounce angle θ4 to the right). At this point, the bounce angle θ5 in the up-down direction is properly calculated as described above. The drive unit 15 is controlled to have the bounce angle θ5 as illustrated in FIG. 12 or 13.

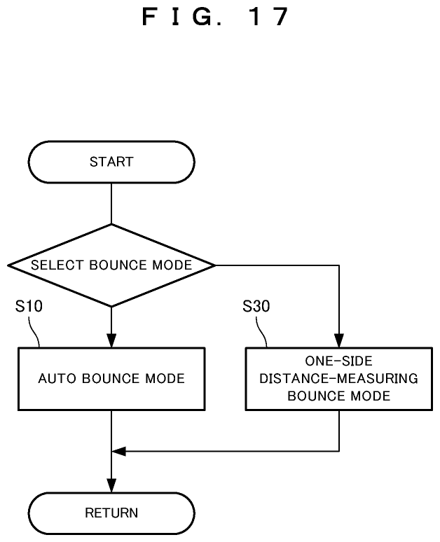

If only the distance Ld from the light-emitting unit 13 to the right side wall H3 is smaller than the distance Lb from the light-emitting unit 13 to the ceiling H1, that is, if the distance Ld from the light-emitting unit 13 to the right side wall H3 is smaller than the distance Lb from the light-emitting unit 13 to the ceiling H1 and the distance Lc from the light-emitting unit 13 to the left side wall H2 is larger than the distance Lb from the light-emitting unit 13 to the ceiling H1, the process advances from step S19 to steps S21 and S22 (see FIG. 10B). With respect to the right-left direction, as illustrated in FIG. 15, the drive unit 15 is controlled to horizontally incline the light-emitting unit 13 toward a position close to the left side wall H2 on the ceiling H1. However, the present invention is not limited to this configuration. In this case, the same operation as in step S23, which will be described later, may be performed (a bounce angle is set such that a target position on the ceiling H1 is located at the center between the left side wall H2 and the right side wall H3: see FIG. 16).

If only the distance Ld from the light-emitting unit 13 to the right side wall H3 is smaller than the distance Lb from the light-emitting unit 13 to the ceiling H1, as indicated in step S22, the drive unit 15 is more preferably controlled such that the position of light emission on the ceiling H1 by the light-emitting unit 13 is located at a position N2 that is shifted from the position directly above the light-emitting unit 13 toward the left side wall H2 according to a dimension corresponding to a difference (Lb−Lc) between the distance Lb to the ceiling H1 and the distance Ld to the right side wall H3 (inclined to a bounce angle θ3 to the left). At this point, the bounce angle θ5 in the up-down direction is properly calculated as described above. The drive unit 15 is controlled to have the bounce angle θ5 as illustrated in FIG. 12 or 13.

If any of the conditions in steps S16, S19, and S21 is not satisfied, that is, if both of the distance Lc from the light-emitting unit 13 to the left side wall H2 and the distance Ld from the light-emitting unit 13 to the right side wall H3 are smaller than the distance Lb to the ceiling H1, the process advances from step S21 to step S23. With respect to the right-left direction, as illustrated in FIG. 16, the drive unit 15 is controlled to direct the light-emitting unit 13 toward a point located at the same distance from the side walls H2 and H3 on the ceiling H1 (a point at a distance (Lc+Ld)/2 from the left side wall H2, that is, a central position between the left side wall H2 and the right side wall H3). The bounce angle θ5 in the up-down direction is properly calculated as described above. The drive unit 15 is controlled to have the bounce angle θ5 as illustrated in FIG. 12 or 13.

When the auto bounce mode is selected in this configuration during bounce photography, the distance sensor 19 serving as a distance measuring unit first measures distances to the subject T, the ceiling H1, the left side wall H2, and the right side wall H3 from the light-emitting unit 13. The control unit 17 then controls the drive unit 15 such that the light-emitting unit 13 has the proper bounce angle based on distances other than the distance to the subject T from the light-emitting unit 13, specifically, the distance Lb from the light-emitting unit 13 to the ceiling H1 serving as a main reflector and the distances Lc and Ld from the light-emitting unit 13 to the left side wall H2 and the right side wall H3 that are reflectors (auxiliary reflectors) other than the main reflector. This can properly illuminate the subject T with flash light while equalizing the levels of reflection to the subject T from the left side wall H2 and the right side wall H3, which serve as reflectors (auxiliary reflectors), as well as a main reflector, e.g., the ceiling H1.

With this configuration, if the distance Lc from the light-emitting unit 13 to one of the side walls (e.g., the left side wall H2) is smaller than the distance Lb from the light-emitting unit 13 to the ceiling H1 and the distance Ld from the light-emitting unit 13 to the other side wall (e.g., the right side wall H3) is larger than the distance Lb from the light-emitting unit 13 to the ceiling H1, as illustrated in FIG. 14, the drive unit 15 is controlled so as to incline the light-emitting unit 13 toward a position close to the other side wall (for example, the right side wall H3) on the ceiling H1.

Unlike in the reflection of flash light to the ceiling H1 without the horizontal inclination of the light-emitting unit 13, this configuration can reduce the amount of reflection from one of the side walls (e.g., the left side wall H2) at a smaller distance than the ceiling H1 and increase the amount of reflection from the other side wall (e.g., the right side wall H3) at a larger distance than the ceiling H1. This equalizes the levels of reflection from one of the side walls (e.g., the left side wall H2) and the other side wall (e.g., the right side wall H3) to the subject, thereby properly illuminating the subject T with flash light.

In this case, as described above, the drive unit 15 is controlled such that the position of light emission on the ceiling H1 by the light-emitting unit 13 is shifted from the position directly above the light-emitting unit 13 toward the other side wall (e.g., the right side wall H3) according to a dimension corresponding to a difference (Lb−Lc) between the distance Lb to the ceiling H1 and the distance Lc to one of the side walls (e.g., the left side wall H2) at a smaller distance than the ceiling H1. Thus, the smaller the distance Lc to one of the side walls (e.g., the left side wall H2) relative to the distance Lb to the ceiling H1 (the larger the difference), the larger the inclination of the position of light emission on the ceiling H1 by the light-emitting unit 13 toward the other side wall (e.g., the right side wall H3). This configuration equalizes more properly the levels of reflection from one of the side walls (e.g., the left side wall H2) and the other side wall (e.g., the right side wall H3) to the subject T, thereby properly illuminating the subject T with flash light.

The drive unit 15 is not necessarily controlled such that the position of light emission on the ceiling H1 by the light-emitting unit 13 is shifted from the position directly above the light-emitting unit 13 toward the other side wall (e.g., the right side wall H3) according to a dimension corresponding to a difference (Lb−Lc) between the distance Lb to the ceiling H1 and the distance Lc to one of the side walls (e.g., the left side wall H2) at a smaller distance than the ceiling H1. The drive unit 15 may be controlled such that the light-emitting unit 13 is directed (inclined) toward a position close to the other side wall (e.g., the right side wall H3) on the ceiling H1 at the distance Ld larger than the distance Lb from the light-emitting unit 13 to the ceiling H1. For example, a difference (Lb−Lc) between the distance Lb from the light-emitting unit 13 to the ceiling H1 and the distance Lc to one of the side walls (e.g., the left side wall H2) at a smaller distance than the ceiling H1 may be set for multiple ranges (e.g., from 0 to 1 m (0 is not included), 1 to 2.5 m, and 2.5 to 5 m). For each of the setting ranges, a position (for example, at 0.3 m, 1 m, or 2 m) shifted from the position directly above the light-emitting unit 13 on the ceiling H1 toward the other side wall (e.g., the right side wall H3) may be set in advance, and an angle of tilt (e.g., 5°, 10°, or 20°) toward the other side wall may be also set in advance. Bounce photography may be performed with the light-emitting unit 13 inclined according to the difference (Lb−Lc) toward the other side wall (e.g., the right side wall H3) from the position directly above the light-emitting unit 13 on the ceiling H1. If the distance Lc from the light-emitting unit 13 to one of the side walls (for example, the left side wall H2) is smaller than the distance Lb from the light-emitting unit 13 to the ceiling H1 and the distance Ld from the light-emitting unit 13 to the other side wall (for example, the right side wall H3) is larger than the distance Lb from the light-emitting unit 13 to the ceiling H1, the drive unit 15 may be controlled such that the light-emitting unit 13 is inclined by a predetermined angle toward the other side wall (for example, the right side wall H3) from the position directly above the light-emitting unit 13 on the ceiling H1.

With this configuration, if the distances Lc and Ld from the light-emitting unit 13 to the left and right side walls H2 and H3 are smaller than the distance Lb from the light-emitting unit 13 to the ceiling H1, the light-emitting unit 13 is automatically directed toward a point at equal distances from the side walls H2 and H3 on the ceiling H1. With this configuration, unlike in the reflection of flash light to the ceiling H1 without the horizontal inclination of the light-emitting unit 13, the levels of reflection of the side walls H2 and H3 are more properly equalized with respect to the subject T, thereby properly illuminating the subject T with flash light.

With this configuration, if the distances Lc and Ld from the light-emitting unit 13 to the left and right side walls H2 and H3 are not smaller than the distance Lb from the light-emitting unit 13 to the ceiling H1, the light-emitting unit 13 is directed toward the ceiling H1 without being horizontally inclined. Thus, even if reflection from the left and right side walls H2 and H3 hardly affects the subject T, the subject T can be preferably illuminated with flash light.

In the present embodiment, the auto bounce mode (subject/ceiling/left-right side wall distance measuring mode) is selected for the automatic determination of a bounce angle, so that distances to both of the left side wall H2 and the right side wall H3 from the light-emitting unit 13 are always measured to determine the bounce angle (automatic bounce mode). The present invention is not limited to the auto bounce mode.

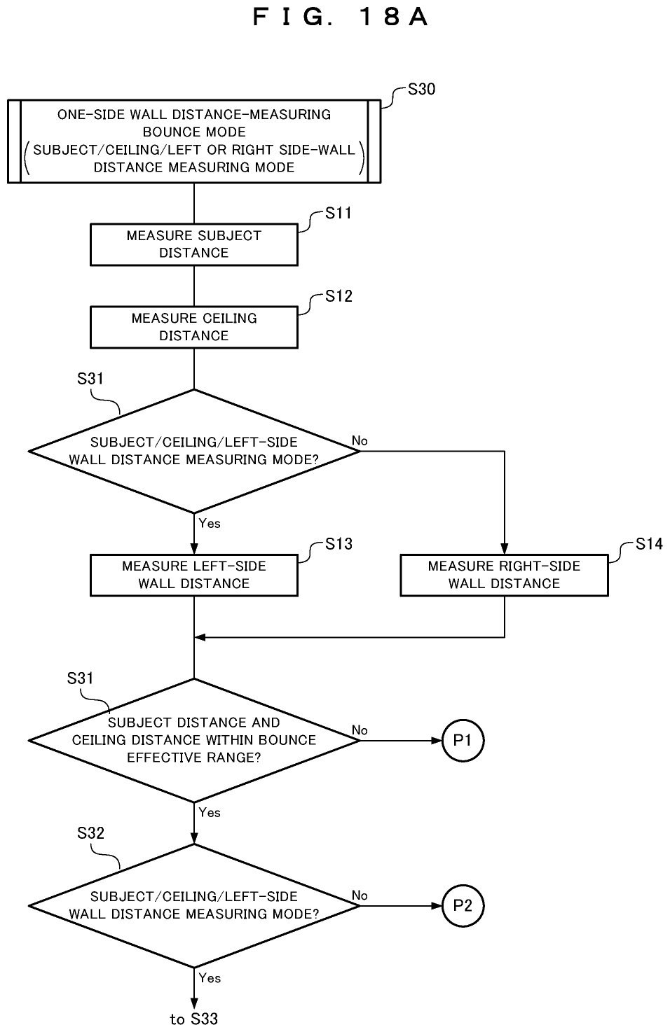

For example, in addition to distances measured from the light-emitting unit 13 to the subject T and the ceiling H1 by the distance sensor 19 serving as a distance measuring unit, a distance is measured from the light-emitting unit 13 to only one of the left side wall H2 and the right side wall H3. In addition to the auto bounce mode (subject/ceiling/left-right side wall distance measuring mode) S10, a one-side distance-measuring bounce mode S30 may be selectively configured to set the tilt angle in the right-left direction (bounce angle) of the light-emitting unit 13 according to the values of the distances (see FIG. 17).

For example, when the one-side distance-measuring bounce mode S30 is selected, a user is required to input one of the left side wall H2 and the right side wall H3 to be measured from the light-emitting unit 13 (for example, the operation unit 18 of the strobe device 10 includes a display unit that displays a selection screen). If a distance (Lc or Ld) from the light-emitting unit 13 to the selected side wall (the left side wall H2 or the right side wall H3) is larger than the distance Lb from the light-emitting unit 13 to the ceiling H1, the control unit 17 of the strobe device 10 controls the drive unit 15 such that the light-emitting unit 13 is directed toward the ceiling without being horizontally inclined. If a distance from the light-emitting unit 13 to one of the side walls (the left side wall H2 or the right side wall H3) is smaller than the distance from the light-emitting unit 13 to the ceiling H1, the drive unit 15 is controlled such that the light-emitting unit 13 is directed (inclined) from a position directly above the light-emitting unit 13 on the ceiling H1 toward a point close to the other side wall (the right side wall H3 or the left side wall H2) opposite to the side wall (the left side wall H2 or the right side wall H3).

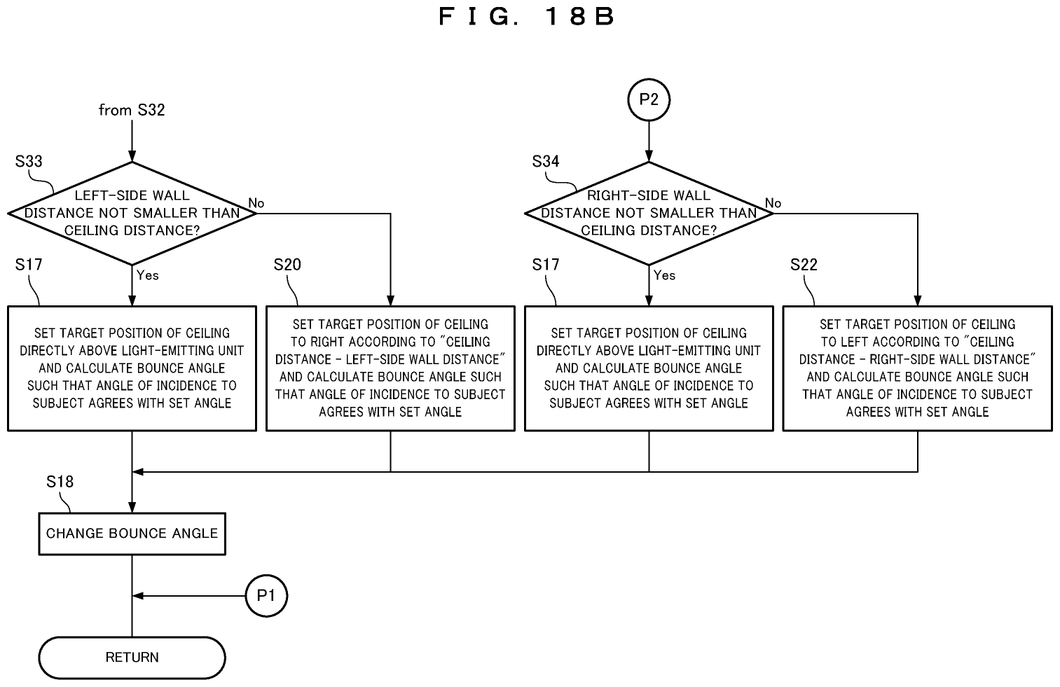

Specifically, as indicated in FIG. 18A, distances from the light-emitting unit 13 to the subject T and the ceiling H1 are measured (steps S11, S12), and then a distance from the light-emitting unit 13 to the selected side wall (the left side wall H2 or the right side wall H3) is measured (steps S31, S13, S14). In step S15, it is determined whether the distances to the subject T and the ceiling H1 fall within a distance range (bounce effective range) for enabling preset bounce photography. In step S15, if at least one of the subject T and the ceiling H1 is located at a distance from the light-emitting unit 13 such that the distance falls outside the bounce effective range, the process is terminated without setting a bounce angle. For example, an error is indicated to provide a notification that the subject T or the ceiling H1 is located at a distance out of the bounce effective range; meanwhile, a normal photo-taking is continued.

In step S15, if it is determined that the distances to the subject T and the ceiling H1 from the light-emitting unit 13 fall within the bounce effective range, the process advances to step S32 to determine whether a mode for measuring a distance from the light-emitting unit 13 to the left side wall H2 is selected or not. If the mode for measuring a distance from the light-emitting unit 13 to the left side wall H2 is selected, the process advances from step S32 to step S33 (see FIG. 18B) to determine whether the distance Lc from the light-emitting unit 13 to the left side wall H2 is not smaller than the distance Lb from the light-emitting unit 13 to the ceiling H1.

In step S33, if the distance Lc from the light-emitting unit 13 to the left side wall H2 is not smaller than the distance Lb from the light-emitting unit 13 to the ceiling H1, the process advances to step S17. As illustrated in FIG. 19, the light-emitting unit 13 is directed toward the ceiling H1 (upward) (a target position on the ceiling H1 is simply set at an upward position) without being horizontally inclined, an angle of incidence to the subject T is calculated to be a set angle suitable for bounce photography, and the drive unit 15 is controlled to have the set angle (step S18).

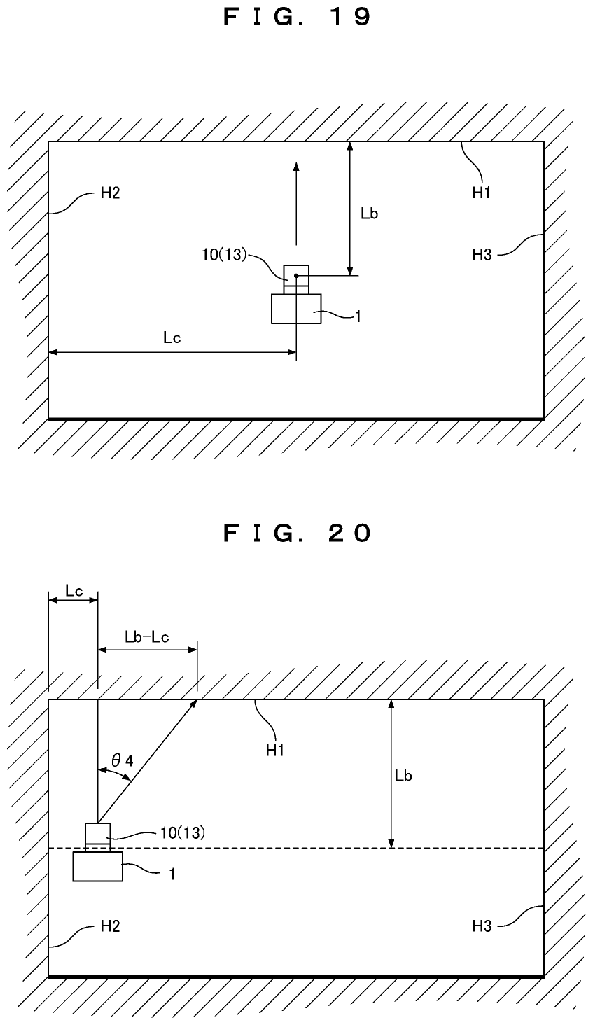

If the distance Lc from the light-emitting unit 13 to the left side wall H2 is smaller than the distance Lb from the light-emitting unit 13 to the ceiling H1, the process advances from step S33 to step S20. With respect to the right-left direction, as illustrated in FIG. 20, the drive unit 15 is controlled such that the light-emitting unit 13 is horizontally inclined toward a position close to the right side wall H3 on the ceiling H1.

If the distance Lc from the light-emitting unit 13 to the left side wall H2 is smaller than the distance Lb from the light-emitting unit 13 to the ceiling H1, as indicated in step S20, the drive unit 15 is more preferably controlled such that the position of light emission on the ceiling H1 by the light-emitting unit 13 is located at a position that is shifted from a position directly above the light-emitting unit 13 toward the right side wall H3 according to a dimension corresponding to a difference (Lb−Lc) between the distance Lb to the ceiling H1 and the distance Lc to the left side wall H2 (inclined to the bounce angle θ4 to the right). At this point, the bounce angle θ5 in the up-down direction is properly calculated as described above. The drive unit 15 is controlled to have the bounce angle θ5 as illustrated in FIG. 12 or 13.

If the mode for measuring a distance from the light-emitting unit 13 to the right side wall H3 is selected, the process advances from step S32 to step S34 to determine whether the distance Ld from the light-emitting unit 13 to the right side wall H3 is not smaller than the distance Lb from the light-emitting unit 13 to the ceiling H1.

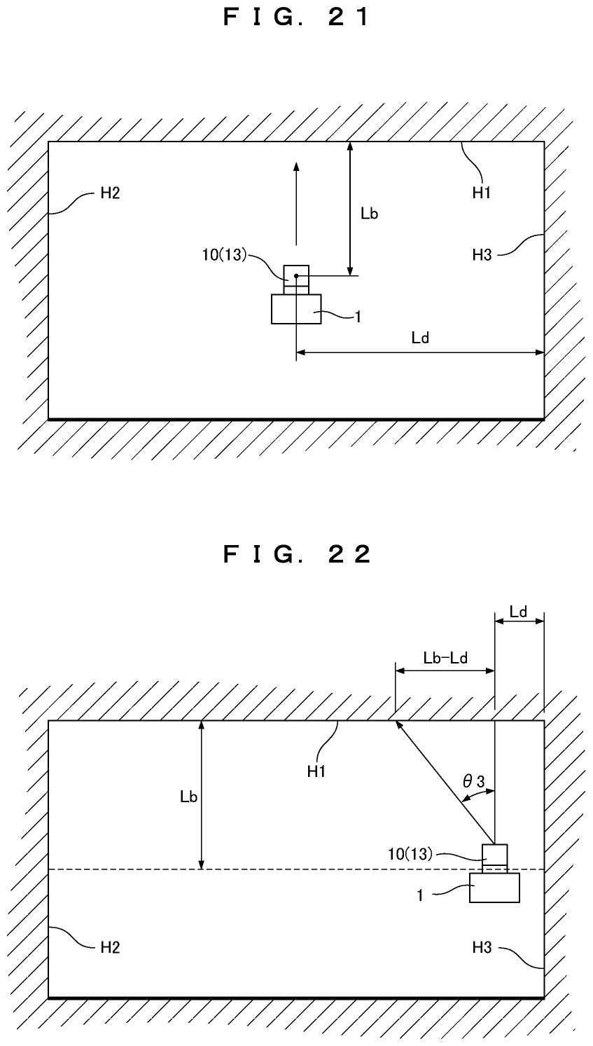

In step S34, if the distance Ld from the light-emitting unit 13 to the right side wall H3 is not smaller than the distance Lb from the light-emitting unit 13 to the ceiling H1, the process advances to step S17. As illustrated in FIG. 21, the light-emitting unit 13 is directed toward the ceiling H1 (upward) (a target position on the ceiling H1 is simply set at an upward position) without being horizontally inclined, an angle of incidence to the subject T is calculated to be a set angle suitable for bounce photography, and the drive unit 15 is controlled to have the set tilt angle (step S18).

If the distance Ld from the light-emitting unit 13 to the right side wall H3 is smaller than the distance Lb from the light-emitting unit 13 to the ceiling H1, the process advances from step S34 to step S22. With respect to the right-left direction, as illustrated in FIG. 22, the drive unit 15 is controlled such that the light-emitting unit 13 is horizontally inclined toward a position close to the left side wall H2 on the ceiling H1.

If the distance Ld from the light-emitting unit 13 to the right side wall H3 is smaller than the distance Lb from the light-emitting unit 13 to the ceiling H1, as indicated in step S22, the drive unit 15 is more preferably controlled such that the position of light emission on the ceiling H1 by the light-emitting unit 13 is located at a position that is shifted from the position directly above the light-emitting unit 13 toward the left side wall H2 according to the dimension of a difference (Lb−Ld) between the distance Lb to the ceiling H1 and the distance Ld to the right side wall H3 (inclined to the bounce angle θ3 to the left). At this point, the bounce angle θ5 in the up-down direction is properly calculated as described above. The drive unit 15 is controlled to have the bounce angle θ5 as illustrated in FIG. 12 or 13.

Also in this configuration, if the distance Lc from the light-emitting unit 13 to one of the side walls (e.g., the left side wall H2) is smaller than the distance Lb from the light-emitting unit 13 to the ceiling H1, as illustrated in FIGS. 20 and 22, the drive unit 15 is controlled so as to incline the light-emitting unit 13 toward a position close to the other side wall (e.g., the right side wall H3) on the ceiling H1. Unlike in the reflection of flash light to the ceiling H1 without the horizontal inclination of the light-emitting unit 13, this configuration can reduce the amount of reflection from one of the side walls at a smaller distance than the ceiling H1 and increase the amount of reflection from the other side wall at a larger distance than the ceiling H1. This substantially equalizes the levels of reflection from one of the side walls and the other side wall to the subject, thereby properly illuminating the subject T with flash light.

This configuration measures only a distance from the light-emitting unit 13 to one of the side walls and eliminates the need for measuring a distance from the light-emitting unit 13 to the other side wall. This can save a distance-measuring operation, achieving bounce photography in a shorter time than in the measurement of distances to both of the left side wall H2 and the right side wall H3.

The embodiment described bounce photography (the auto bounce mode S10 and the one-side distance-measuring bounce mode S30) on the ceiling H1 along with the left and right side walls H2 and H3 (the ceiling H1 serves as a main reflector). The present invention is not limited to this configuration. Bounce photography may be performed in a side-wall bounce mode (subject/ceiling/left or right side-wall distance measuring mode) S40 (the left side wall H2 or the right side wall H3 serves as a main reflector) on the side wall (the left side wall H2 or the right side wall H3) being a center. In this case, the operation unit 18 is operated so as to select the side-wall bounce mode S40. Furthermore, a distance to the subject T or the side wall (maximum effective distance) is preset to enable bounce photography.

In this case, the left side wall H2 or the right side wall H3 is selected as a main reflector, causing the distance sensor 19, which acts as a distance measuring unit, to measure a distance from the light-emitting unit 13 to the main reflector, that is, one of the left side wall H2 and the right side wall H3, and the distance Lb to the auxiliary reflector, that is, the ceiling H1. The control unit 17 is configured to control the drive unit such that the light-emitting unit 13 is inclined toward the ceiling H1 on one of the side walls (the left side wall H2 or the right side wall H3) according to the distance from the light-emitting unit 13 to the side wall serving as a main reflector and the distance Lb to the ceiling H1.

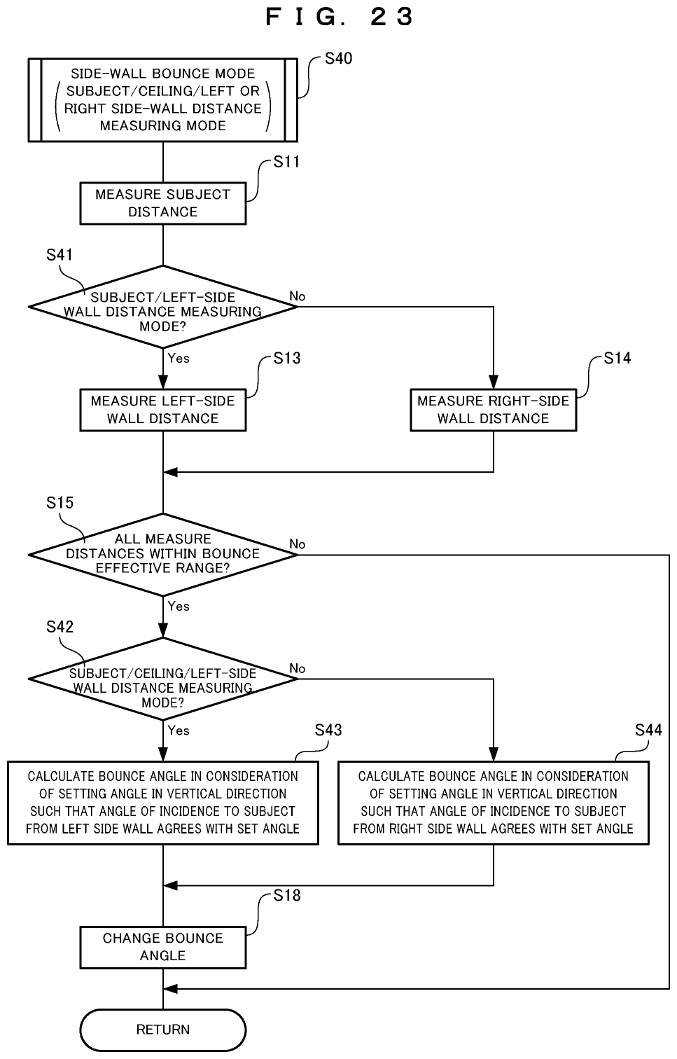

If the side-wall bounce mode S40 is selected, specifically, as indicated in FIG. 23, a distance from the light-emitting unit 13 to the subject T is measured (step S11), and then a distance from the light-emitting unit 13 to the side wall selected as a main reflector (the left side wall H2 or the right side wall H3) is measured (steps S41, S13, S14). In step S15, it is determined whether the distances from the light-emitting unit 13 to the subject T, the selected side wall, and the ceiling H1 fall within the distance range (bounce effective range) for enabling preset bounce photography. In step S15, if the subject T and any one of the reflectors are located at distances from the light-emitting unit 13 such that the distances fall outside the bounce effective range, the process is terminated without setting a bounce angle. For example, an error is indicated to provide a notification that the subject T, the ceiling H1, or the side wall H2 or H3 is located at a distance from the light-emitting unit 13 out of the bounce effective range; meanwhile, a normal photo-taking is continued.

In step S15, if it is determined that the distances to the subject T and all the reflectors from the light-emitting unit 13 fall within the bounce effective range, the process advances to step S42 to determine the side wall as a main reflector based on information on the side wall selected as a main reflector (step S42). For example, if the left side wall H2 is used as a main reflector, the process advances from step S42 to step S43 to calculate a bounce angle in consideration of a bounce setting angle in the vertical direction such that an angle of incidence to the subject T from the left side wall H2 agrees with a set bounce angle (step S18).

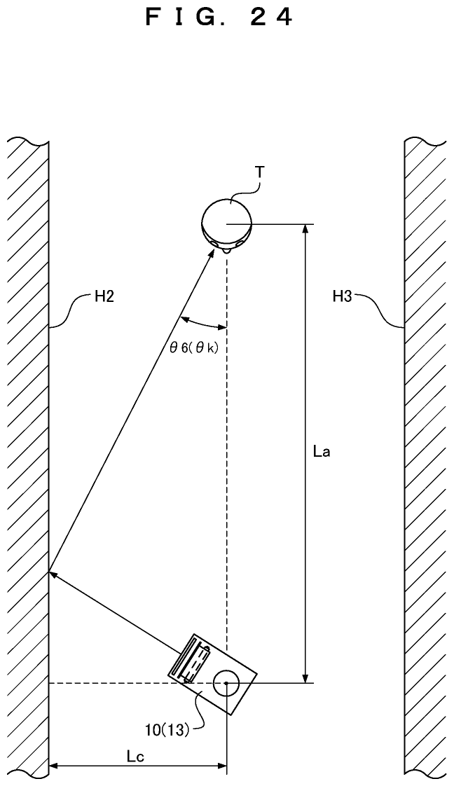

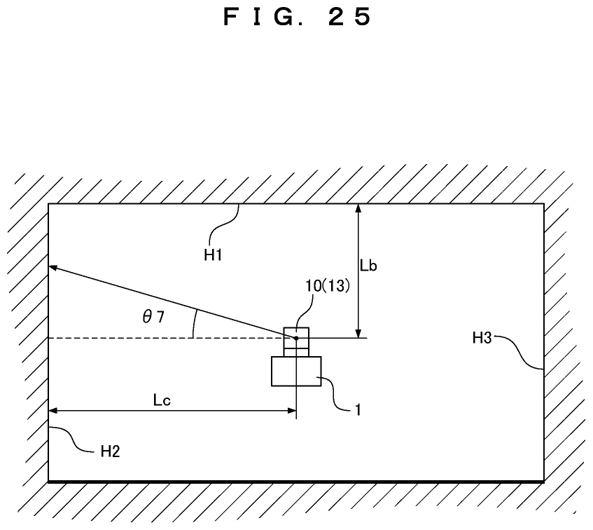

For example, a bounce angle θ7 for upward inclination (see FIG. 25) is set according to the distance Lb from the light-emitting unit 13 to the ceiling H1 and the distance La from the light-emitting unit 13 to the subject T such that the bounce angle for upward inclination increases with the distance Lb from the light-emitting unit 13 to the ceiling H1. Moreover, a bounce angle θ6 in the right-left direction is preferably determined (see FIG. 24) according to the distance Lc from the light-emitting unit 13 to the left side wall H2 serving as a main reflector and the distance La from the light-emitting unit 13 to the subject T such that an angle of incidence to the subject T agrees with a predetermined reference angle (e.g., about 30°) θk. The present invention is not limited to the setting of a bounce angle. A bounce angle may be set such that the angle of incidence of flash light to the left side wall H2 agrees with the angle of outgoing flash light from the left side wall H2 to the subject T. In this way, an angle of incidence to the subject T from the left side wall H2 is set in consideration of a bounce setting angle in the vertical direction.

If the right side wall H3 is used as a main reflector, the process advances from step S42 to step S44 to calculate a bounce angle in consideration of a bounce setting angle in the vertical direction such that an angle of incidence to the subject T from the right side wall H3 agrees with a set bounce angle (step S18).

For example, the bounce angle θ7 for upward inclination is set according to the distance Lb from the light-emitting unit 13 to the ceiling H1 and the distance La from the light-emitting unit 13 to the subject T such that the bounce angle for upward inclination increases with the distance Lb from the light-emitting unit 13 to the ceiling H1. Moreover, the bounce angle θ6 in the right-left direction is preferably determined according to the distance Ld from the light-emitting unit 13 to the right side wall H3 serving as a main reflector and the distance La from the light-emitting unit 13 to the subject T such that an angle of incidence to the subject T agrees with the predetermined reference angle (e.g., about 30°) θk. The present invention is not limited to the setting of a bounce angle. A bounce angle may be set such that the angle of incidence of flash light to the right side wall H3 agrees with the angle of outgoing flash light from the right side wall H3 to the subject T. In this way, an angle of incidence to the subject T from the right side wall H3 is set in consideration of a bounce setting angle in the vertical direction.

With this configuration, mainly in the case of photo-taking with flash light reflected from the left side wall H2 or the right side wall H3, the subject T can be properly illuminated with flash light along with reflected light from the ceiling H1 while suppressing a shadow of the subject T in a direction opposite to the side wall serving as a main reflector.

With this configuration, as illustrated in FIG. 24, a bounce angle is determined for the main reflector such that the angle of incidence to the subject T agrees with the predetermined reference angle (e.g., about 30°), thereby advantageously maximizing the effect of bounce photography in any photo-taking environments unlike in the case where the angle of incidence of flash light to the ceiling H1 and the angle of outgoing flash light from the ceiling H1 to the subject T agree with each other. In other words, if the light-emitting unit 13 is inclined such that an angle of incidence to the side wall serving as a main reflector and an angle of reflection agree with each other, the angle of incidence can be changed according to distances to the subject T and the side wall serving as a main reflector. As the angle of incidence changes according to a distance from the light-emitting unit 13, the ratio of lateral light varies during bounce photography. This changes the effect of bounce photography, accordingly. An extremely small angle of incidence to the subject T may cause a photo-taking result like direct light at worst, substantially eliminating the effect of bounce photography. To address the problem, as illustrated in FIG. 24, the angle of incidence is always controlled at an optimum tilt angle for bounce photography (for example, the angle of incidence to the subject T is set at 30°, a reference tilt angle), thereby maximizing the effect of bounce photography in any photo-taking environments.

In the embodiment, if any one of the side walls is used as a main reflector, a bounce angle is set in consideration of a bounce setting angle in the vertical direction such that an angle of incidence to the subject T from the side wall (e.g., the left side wall H2) agrees with the set bounce angle. The present invention is not limited to the setting of a bounce angle. For example, the drive unit 15 may be controlled to incline the light-emitting unit 13 toward the ceiling H1 on one of the side walls H2 and H3 only in the case where the distance Lb from the light-emitting unit 13 to the ceiling H1 is smaller than the distances Lc and Ld to one of the side walls H2 and H3 serving as a main reflector.

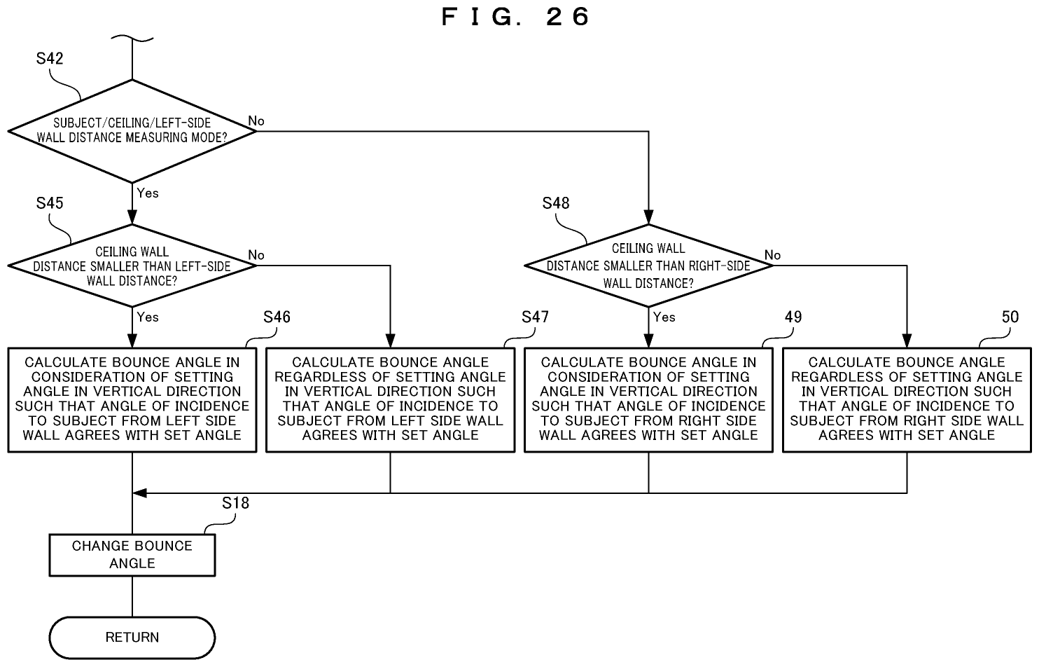

In this case, as indicated in FIG. 26, if the main reflector is, for example, the left side wall H2 in step S42 of the embodiment, the process advances from step S42 to step S45. If the distance Lb from the light-emitting unit 13 to the ceiling H1 is smaller than the distance Lc to the left side wall H2 serving as a main reflector, the drive unit 15 is controlled such that the light-emitting unit 13 is also inclined toward the ceiling H1 on the left side wall H2 (see step S46 and FIG. 25). If the distance Lb from the light-emitting unit 13 to the ceiling H1 is not smaller than the distance Lc to the left side wall H2 serving as a main reflector, the drive unit 15 is controlled without inclining the light-emitting unit 13 toward the ceiling H1 on the left side wall H2 (regardless of a setting angle in the vertical direction) (step S47).

If the right side wall H3 serves as a main reflector, the process advances from step S42 to step S48. If the distance Lb from the light-emitting unit 13 to the ceiling H1 is smaller than the distance Ld to the right side wall H3 serving as a main reflector, the drive unit 15 is controlled such that the light-emitting unit 13 is also inclined toward the ceiling H1 on the right side wall H3 (step S49). If the distance Lb from the light-emitting unit 13 to the ceiling H1 is not smaller than the distance Ld to the right side wall H3 serving as a main reflector, the drive unit 15 is controlled without inclining the light-emitting unit 13 toward the ceiling H1 on the right side wall H3 (regardless of a setting angle in the vertical direction) (step S50).

With this configuration, also regarding the side wall serving as a main reflector, the light-emitting unit 13 can be also inclined toward the ceiling H1 only in the case where the distance Lb from the light-emitting unit 13 to the ceiling H1 is smaller than the distances Lc and Ld to the side walls H2 and H3 serving as main reflectors, that is, bounce light from the ceiling H1 considerably affects the subject T. Thus, the subject T can be properly illuminated with flash light.

The embodiment described bounce photography in a space having the ceiling H1. If the ceiling H1 is not provided or a distance from the light-emitting unit 13 to the ceiling H1 is extremely large, as illustrated in FIG. 24, a bounce angle is preferably determined for the side wall serving as a main reflector such that the angle of incidence to the subject T agrees with the predetermined reference angle (e.g., about 30°) (side-wall-alone bounce mode). In other words, as illustrated in FIG. 24, the angle of incidence is always controlled at an optimum tilt angle for bounce photography (for example, the angle of incidence to the subject T is set at 30°, a reference tilt angle), thereby maximizing the effect of bounce photography in any photo-taking environments.

In an example other than the side-wall-alone bounce mode according to the embodiment, a plurality of reflectors including a main reflector and other reflectors are taken into consideration for bounce photography in a space having a ceiling and left and right side walls. The present invention is not limited to the example. For example, also in bounce photography in a space including a plurality of reflectors, a ceiling bounce-photography mode not involving horizontal inclination may be selectable on the assumption that light is reflected only from the ceiling. Alternatively, the side-wall-alone bounce mode not involving vertical inclination may be selectable on the assumption that light is reflected only from the left side wall or the right wide wall.

### REFERENCE SIGNS LIST

1 Imaging device

3 Photo-taking function unit

4 Control unit

5 Display unit

6 Operation unit

7 Peripheral I/F (interface)

8 Shutter

10 Strobe device

11 Strobe main unit

12 Stroboscopic tube

13 Light-emitting unit

14 Adjustable mechanism

15 Drive unit

16 Angle detection unit

17 Control unit

18 Operation unit

19 Distance sensor (distance measuring unit)

20 Capacitor (power accumulator)

21 Arithmetic unit

22 Storage unit

1. A strobe device comprising:
a strobe main unit;
a light-emitting unit connected to the strobe main unit so as to rotate in three-dimensional directions:
an up-down direction, a front-back direction, and a right-left direction with respect to the strobe main unit;
an adjustable mechanism for changing an angle and orientation of the light-emitting unit with respect to the strobe main unit in the rotatable range;
a drive unit for driving the adjustable mechanism; and
a control unit for controlling the drive unit,
the strobe device enabling bounce photography in which flash light is emitted to a reflector so as to illuminate a subject with light reflected from the reflector including a ceiling and side walls that reflect the flash light,
the strobe device further comprising a distance-measuring unit capable of measuring distances from the light-emitting unit to the subject, the ceiling, and at least one of the left side wall and the right side wall,
wherein the control unit controls the drive unit such that the light-emitting unit has a bounce angle based on distances other than a distance from the light-emitting unit to the subject, the distances including a distance from the light-emitting unit to a main reflector that is the ceiling or one of the left side wall and the right side wall and distances from the light-emitting unit to auxiliary reflectors other than the main reflector.

2. The strobe device according to claim 1, wherein the distance-measuring unit is capable of measuring distances from the light-emitting unit to the subject, the ceiling, the left side wall, and the right side wall, and
if the distance from the light-emitting unit to one of the side walls is smaller than the distance from the light-emitting unit to the ceiling and the distance from the light emitting unit to the other side wall is larger than the distance from the light-emitting unit to the ceiling, the control unit controls the drive unit so as to incline the light-emitting unit toward a position close to the other side wall on the ceiling.

3. The strobe device according to claim 2, wherein if the distance from the light-emitting unit to one of the side walls is smaller than the distance from the light-emitting unit to the ceiling and the distance from the light-emitting unit to the other side wall is larger than the distance from the light-emitting unit to the ceiling, the control unit controls the drive unit such that a position of light emission on the ceiling by the light-emitting unit is shifted from a position directly above the light-emitting unit toward the other side wall according to a dimension corresponding to a difference between the distance to the ceiling and the distance to one of the side walls.

4. The strobe device according to claim 1, wherein the distance-measuring unit is capable of measuring distances from the light-emitting unit to the subject, the ceiling, the left side wall, and the right side wall, and
if the distances from the light-emitting unit to one of the side walls and the other side wall are smaller than the distance from the light-emitting unit to the ceiling, the control unit controls the drive unit such that the light-emitting unit is directed toward a point at equal distances from the side walls on the ceiling.

5. The strobe device according to claim 1, wherein the distance-measuring unit is capable of measuring distances from the light-emitting unit to the subject, the ceiling, the left side wall, and the right side wall, and
if the distances from the light-emitting unit to the side walls are not smaller than the distance from the light-emitting unit to the ceiling, the control unit controls the drive unit such that the light-emitting unit is directed toward the ceiling without being horizontally inclined.

6. The strobe device according to claim 1, wherein the distance-measuring unit measures distances from the light-emitting unit to the subject, the ceiling, and one of the left side wall and the right side wall, and
if the distance from the light-emitting unit to one of the side walls is larger than the distance from the light-emitting unit to the ceiling, the control unit controls the drive unit such that the light-emitting unit is directed toward the ceiling without being horizontally inclined, and if the distance from the light-emitting unit to one of the side walls is smaller than the distance from the light-emitting unit to the ceiling, the control unit controls the drive unit so as to incline the light-emitting unit toward a position close to the other opposite side wall on the ceiling.

7. The strobe device according to claim 6, wherein if the distance from the light-emitting unit to one of the side walls is smaller than the distance from the light-emitting unit to the ceiling, the control unit controls the drive unit such that a position of light emission on the ceiling by the light-emitting unit is shifted from a position directly above the light-emitting unit toward the other side wall according to a dimension corresponding to a difference between the distance to the ceiling and the distance to one of the side walls.

8. The strobe device according to claim 1, wherein the distance-measuring unit measures a distance from the light-emitting unit to the main reflector including one of the left side wall and the right side wall and a distance from the light-emitting unit to the auxiliary reflector including the ceiling, and
the control unit controls the drive unit such that the light-emitting unit is inclined toward a position close to the ceiling on one of the left side wall and the right side wall according to the distance from the light-emitting unit to one of the side walls and the distance from the light-emitting unit to the ceiling.

9. The strobe device according to claim 8, wherein if the distance from the light-emitting unit to the ceiling is smaller than the distance from the light-emitting unit to one of the side walls, the control unit controls the drive unit so as to incline the light-emitting unit toward a position close to the ceiling on one of the side walls.

10. An imaging device comprising the strobe device according to claim 1.
